(19) United States
(12) Patent Application Publication
(10) Pub. No.: US 2007/0259127 A1
(43) Pub. Date: Nov. 8, 2007

(54) Method for densifying sol-gel films to form microlens structures

(75) Inventors: Yoshi Ono, Camas, WA (US); Bruce D. Ulrich, Beaverton, OR (US); Wei-Wei Zhuang, Vancouver, WA (US); Douglas J. Tweet, Camas, WA (US)

Correspondence Address: David C. Ripma;Sharp Laboratories of America, Inc., 5750 NW Pacific Rim Boulevard, Camas, WA, 97202, US

(73) Assignee: Sharp Laboratories of America, Inc.

(21) Appl. No.: 11/416,986

(22) Filed: May 2, 2006

(51) Int. Cl. B05D 5/06; B05D 3/12; B05D 3/02; H05H 1/00

(52) U.S. Cl. 427/539; 427/162; 427/240; 427/372.2

(57) ABSTRACT

A method for densifying sol-gel films to form microlens structures includes preparing a sol-gel precursor, having at least one solvent therein. The sol-gel precursor is spin coated onto a wafer to form a sol-gel film thereon. The wafer and sol-gel film are hot plate baked at a temperature less than 200° C. to remove at least some of the solvent. The baked, wafer and spin-coated sol-gel film are treated with an oxygen plasma treatment to remove any remaining solvent and to densify the sol-gel film. The spin coating, hot plate baking and treating steps may be repeated as required. A microlens is formed from the densified sol-gel film.

### FIELD OF THE INVENTION

This invention relates to image sensing devices, and specifically to a method of improving the light collection efficiency for image sensing in CCD and CMOS imagers.

### BACKGROUND OF THE INVENTION

The collection of light onto an active element of a light sensor, e.g., a CCD or CMOS imager, is typically achieved through the placement of one or more lenses above each pixel element. The lens or lenses are comprised of a material having a high refractive index when compared to the overlying or underlying films. The angle of incidence with respect to the interface and the values of refractive index determine the extent of refraction of the light. The shape of the lens thus determines the extent of convergence or divergence of a beam of light. An ideal lens material not only needs to have a high refractive index but also needs to be transparent.

One of the leading candidates for the microlens is titanium dioxide (TiO₂) having a bulk refractive index of as high as 2.3, however most deposited films fall short of the maximum value, and have values closer to 2.0, Rantala et al., Optical properties of spin-on deposited low temperature titanium oxide thin films, Optics Express, vol. 11, No. 12, pp 1406-1410 (2003). A large number of liquid precursors exist that allows films of TiO₂ to be spin coated. Hot plate bake processes, at temperatures of 300° C., are typically used to density spin-coated TiO₂ films. In some image sensor device applications, where organic color filter materials are already deposited, temperatures greater than 200° C. are not tolerable. A method to density a spin-on TiO₂ precursor without exceeding 200° C. is highly desirable.

### SUMMARY OF THE INVENTION

A method for densifying sol-gel films to form microlens structures includes preparing a sol-gel precursor, having at least one solvent therein. The sol-gel precursor is spin coated onto a wafer to form a sol-gel film thereon. The wafer and sol-gel film are hot plate baked at a temperature less than 200° C. to remove at least some of the solvent. The baked, wafer and spin-coated sol-gel film are treated with an oxygen plasma treatment to remove any remaining solvent and to density the sol-gel film. The spin coating, hot plate baking and treating steps may be repeated as required. A microlens is formed from the densified sol-gel film.

It is an object of the invention to form a dense layer of TiO₂.

Another object of the method of the invention is to form a layer of TiO₂ without exceeding a 200° C. process temperature.

A further object of the method of the invention is to form a layer of TiO₂ which exhibits a high refractive index.

This summary and objectives of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWINGS

FIG. 1 is a block diagram of the method of the invention.

FIG. 2 is a thermal gravimetric analysis of TiO₂ precursor EXP04048

FIG. 3 is a thermal gravimetric analysis of TiO₂ precursor A14.

FIG. 4 is a refractive index of TiO₂ films after oxygen plasma compared to hot plate bakes.

FIG. 5 is a refractive index n plotted vs wavelength for multifilms stacks.

FIG. 6 is a refractive index k plotted vs wavelength for multifilms stacks.

### DETAILED DESCRIPTION OF THE PREFERRED EMBODIMENTS

The invention provides a method of generating a dense layer of TiO₂ which exhibits a high refractive index, without exceeding a 200° C. process temperature. The process needs to have a high throughput, low cost, and must be compatible with conventional silicon processing techniques. Because spin-on, sol-gel or MOD, techniques are relatively inexpensive and fast, the technique disclosed herein is applied to such precursors. The resulting film readily accepts subsequent patterning and etching to form the completed microlens array, without detrimental effects to the lens. Often times, shrinkage of spin-on films leads to severe densification, accompanied by cracking and peeling of the film. The method of the invention avoids such problems.

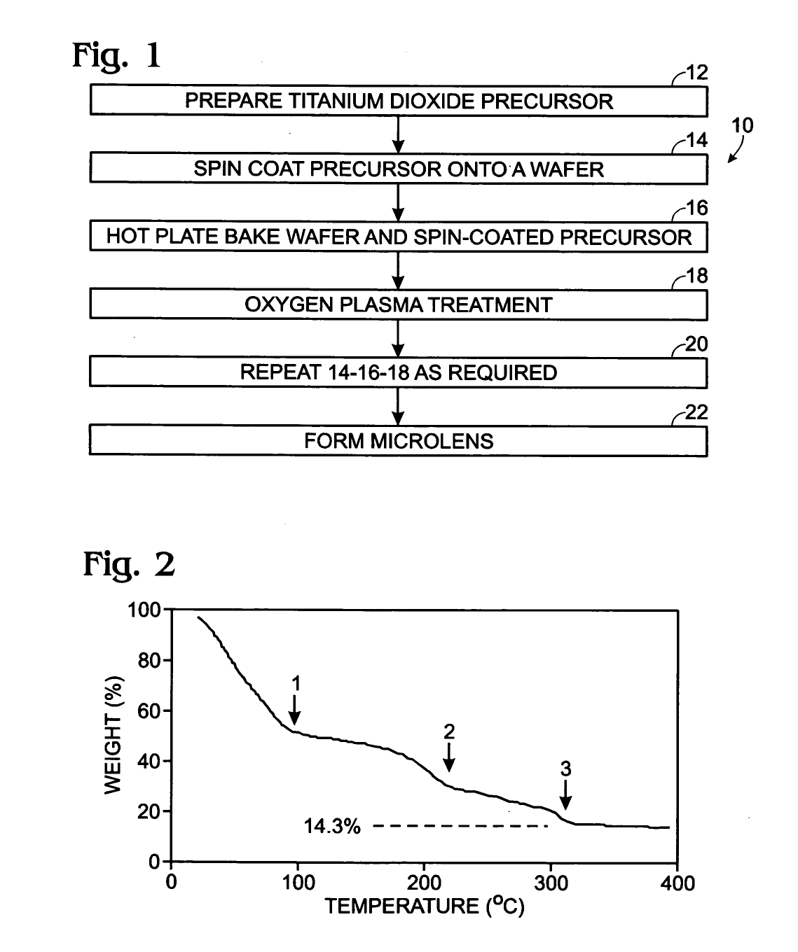

Referring to FIG. 1, the method of the invention is depicted generally at 10. A TiO₂ precursor is prepared 12 and is spin coated 14 on a wafer at about 2000 RPM. The spin-coated wafer is than hot plate baked 16 at a temperature no higher than 180° C. for no more than five minutes, thus maintaining the coated wafer at a temperature below the critical maximum temperature of 200° C. An oxygen plasma treatment is performed 18 in a vacuum chamber, where a low flow of oxygen is introduced and an RF plasma discharge is struck for at least two minutes. The spin coating, hot plate baking, plasma treating sequence may be repeated 20 up to five times without encountering detrimental effects. The film is then ready for lens formation steps 22 where photoresist is applied, patterned to form an array of bumps, followed by a pattern transfer etch.

A number of spin-on precursors for TiO₂ film deposition exist. The formulation of the precursor influences the final film density, refractive index, transparency, stress, adhesion, and susceptibility to cracks. The precursor used for this invention happens to be an experimental material developed by Brewer Science named EXPO4048. The thermal gravimetric analysis (TGA) of EXPO4048 is shown in FIG. 2. It is clear that at least three major solvent components exist in this precursor, each getting desorbed in a different temperature range. Solvent 1 is nearly completely removed at about 100° C. and solvents 2 and 3 at 220° C. and 320° C., respectively. Another material is EXPO4054, which has similar properties, and which also may be used.

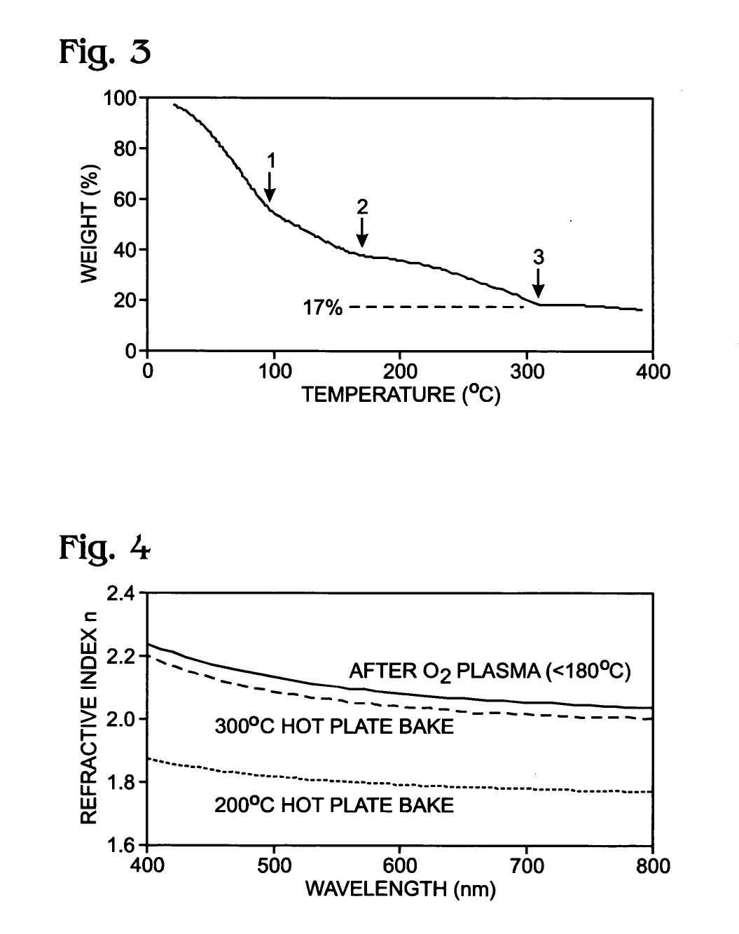

It is clear that the final lens material is comprised of the remnant of the precursor, which is only 14.3% (weight %) of the original film. It is also clear that at temperatures below 200° C., extended baking durations will be required to remove solvent 2. It is also clear that it will not be possible to entirely remove solvent 3 using a typical thermal bake process at the requisite temperatures. In addition to EXPO4048, a commercially available precursor, A14, also manufactured by Brewer Science exhibits similar TGA behavior, as shown in FIG. 3. Solvent 2 is removed at a lower temperature in this case but full densification still requires temperatures in excess of 300° C. This precursor is described in Flaim et al., High refractive index polymer coatings for optoelectronics applications, SPIE Proceedings of Optical Systems Design, Vol. 5250-53 (2003).

A typical spin-on procedure involves dispensing approximately two milliliters of precursor onto a 150 mm substrate, spinning at 300 RPM, and then ramping the rotation to 2000 RPM for thirty seconds. This is followed by a sequence of three hot plate bakes at temperatures of 100° C., 100° C., and 180° C. for 2 minutes each. This successfully removes solvent 1, leaving approximately 50% of the original precursor on the wafer. So far, the processing sequence is quite standard and is performed on typical spin-coating apparatus.

In this disclosure, a key step is an exposure to an oxygen plasma with the wafer at approximately 165° C. for a duration of three minutes. The system used is a plasma asher manufactured by Matrix, normally used for the removal of photoresist. A vacuum chamber, without loadlocking, is used, so that the base pressure is not critical. The wafer chuck sits at 200° C., however, poor contact between the chuck and the wafer keeps the wafer temperature below 180° C. Actual measurements reveal that the wafer temperature is about 165° C. A low oxygen flow, of about 25 sccm, is introduced at a pressure of about 2.5 Torr. A 13.56 MHz RF ignites the plasma at 400 W, which densifies the film.

The oxygen plasma generates a highly reactive species that effectively consumes the remaining solvent in the film, resulting in gaseous carbon dioxide, and other oxides, which are effectively pumped out of the vacuum chamber. The refractive index of the film compares favorably to hot plate baked films, as shown in FIG. 4. The noticeably higher refractive index, compared to the 300° C. baked sample, indicates more efficient film densification using the method of the invention.

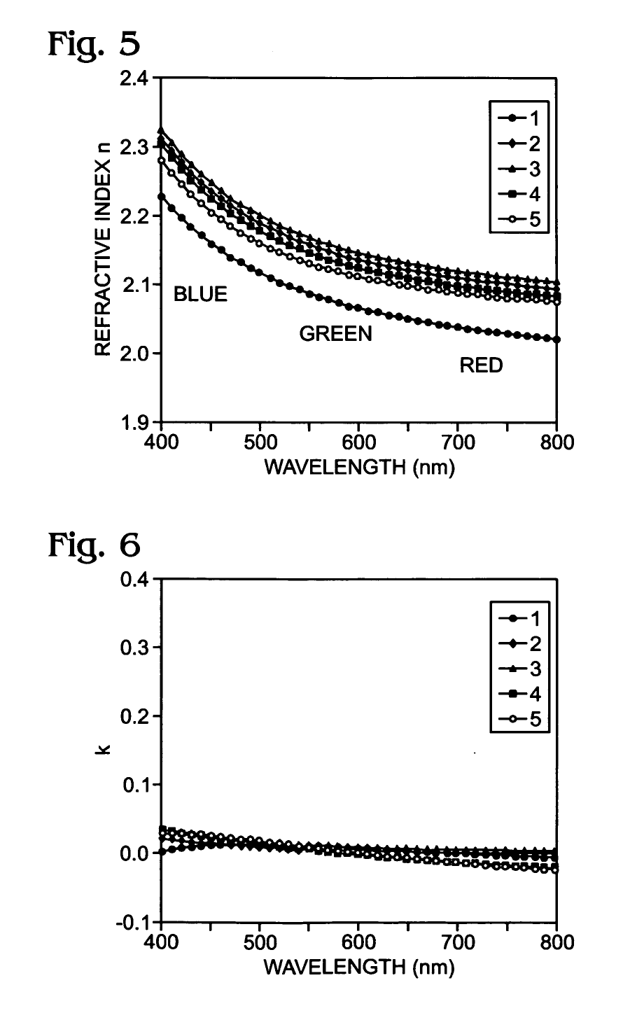

The oxygen plasma technique may be performed for each layer of a multi-layer stack. A five layer film stack has been fabricated without exhibiting cracking or peeling. The resulting refractive index for the full stack appears to be slightly higher than the single film as shown in FIG. 5.

The use of an oxygen plasma for film modification is not new. The application of oxygen plasma to the removal of photoresist is widespread in the industry. It has been used to incorporate oxygen to modify oxygen content in a lanthanide calcium manganate single crystal film, Kim et al., Oxygen-plasma effects of a La_{0.7}Ca_{0.3}MnO_{3-δ} single crystal, Appl. Phys. Lett., Vol. 79, No. 23, pp 4177-4179 (2001), to improve the ferroelectric properties of lead-zirconate-titanate (PZT) films, Jang et al., Oxygen-plasma effects on sol-gel-derived lead-zirconate-titanate thin films, Appl. Phys. Lett., Vol. 76, No. 7, pp 882-884 (2000), and to crystallize amorphous films, Ohsaki et al., Room Temperature crystallization of amorphous thin films by RF plasma treatment, Optical Society of America, Proceedings of Optical Interference Coatings, MF2, Jun. 27-Jul. 2, 2004.

In the method of the invention, oxygen plasma is used to assist in the solvent removal through the introduction of the reactive oxygen species that will convert the residual solvent into gaseous species. Its use must be well coordinated with the spin-coat process, otherwise film cracking will result. A prolonged duration, e.g., greater than one hour, in an ambient atmosphere prior to the plasma treatment will lead to cracked films. It is believed that moisture uptake by the film is detrimental when combined with the oxygen plasma because the plasma is not effective to remove water.

The preferred embodiment of the invention uses the Brewer Science precursor EXPO4048, EXPO4054, or other, closely related materials. The film is spin coated at about 2000 RPM and hot plate baked at a temperature no higher than 180° C. for no more than five minutes. An oxygen plasma treatment is performed in a vacuum chamber, where a low flow of oxygen is introduced and an RF plasma discharge is struck at a power of about 200 W for a 150 mm wafer, for at least two minutes. The spin coat, hot plate bake, plasma treatment sequence may be repeated up to five times without encountering detrimental effects.

The film is then ready for lens formation steps where photoresist is applied, patterned to form an array of bumps, followed by a pattern transfer etch.

Alternatively, other TiO₂ precursors may be used. Precursors which are primarily polymer or organic based are most effective because carbon dioxide, nitrogen oxides, and sulphur oxides, are all volatile. Non-volatile and non-organic constituents should be avoided. Alternative precursors may require longer durations of exposure to the oxygen plasma because solvents which are not sufficiently volatile may fail to densify. The choice of precursor will also impact the threshold at which cracks form.

The requirements of the oxygen plasma are not as demanding. A rough vacuum with any exposure to reactive oxygen species is expected to accomplish the task. A large range of pressures, oxygen flows, and plasma conditions should be effective. Confirmation of the efficacy of the oxygen plasma treatment can be made through spectroscopic ellipsometry.

Thus, a method for densifying sol-gel films to form microlens structures has been disclosed. It will be appreciated that further variations and modifications thereof may be made within the scope of the invention as defined in the appended claims.

We claim:

1. A method for densifying sol-gel films to form microlens structures, comprising:
preparing a sol-gel precursor, having at least one solvent therein;
spin coating the sol-gel precursor onto a wafer to form a sol-gel film thereon;
hot plate baking the wafer and the spin-coated sol-gel film at a temperature less than 200° C. to remove at least some of the solvent;
treating the wafer and spin-coated sol-gel film with an oxygen plasma treatment to remove any remaining solvent and to densify the sol-gel film;
repeating said spin coating, hot plate baking and treating steps as required; and
forming a microlens from the densified sol-gel film.

2. The method of claim 1 wherein said treating the wafer includes placing the wafer in a vacuum chamber at a pressure maintained at about 2.5 Torr, and with an oxygen flow of about 25 sccm, and providing an RF burst of about 400 W at about 13.56 MHz RF, thereby to ignite the plasma and densify the film.

3. The method of claim 1 wherein said spin coating includes spinning the wafer at an initial rate of about 300 RPM and then accelerating the wafer to a rate of about 2000 RPM for about thirty seconds.

4. The method of claim 1 wherein said hot plate baking includes a sequence of three hot plate bakes at temperatures of 100° C., 100° C., and 180° C., respectively, for about two minutes each.

5. The method of claim 1 wherein said preparing a sol-gel precursor includes preparing a sol-gel precursor having titanium dioxide therein.

6. A method for densifying TiO₂ sol-gel film to form microlens structures, comprising:
preparing a precursor, having TiO₂ and at least one solvent therefor therein, to form a TiO₂ precursor;
spin coating the TiO₂ precursor onto a wafer to form a TiO₂ film thereon;
hot plate baking the wafer and the spin-coated TiO₂ film at a temperature less than 200° C. to remove at least some of the solvent;
treating the wafer and spin-coated TiO₂ film with an oxygen plasma treatment to remove any remaining solvent and to densify the TiO₂ film;
repeating said spin coating, hot plate baking and treating steps as required; and
forming a microlens from the densified TiO₂ film.

7. The method of claim 6 wherein said treating the wafer includes placing the wafer in a vacuum chamber at a pressure maintained at about 2.5 Torr, and with an oxygen flow of about 25 sccm, and providing an RF burst of about 400 W at about 13.56 MHz RF, thereby to ignite the plasma and density the TiO₂ film.

8. The method of claim 6 wherein said spin coating includes spinning the wafer at an initial rate of about 300 RPM and then accelerating the wafer to a rate of about 2000 RPM for about thirty seconds.

9. The method of claim 6 wherein said hot plate baking includes a sequence of three hot plate bakes at temperatures of 100° C., 100° C., and 180° C., respectively, for about two minutes each.

10. A method for densifying TiO₂ sol-gel film to form microlens structures, comprising:
preparing a precursor, having TiO₂ and at least one solvent therefor therein, to form a TiO₂ precursor;
spin coating the TiO₂ precursor onto a wafer to form a TiO₂ film thereon;
hot plate baking the wafer and the spin-coated TiO₂ film at a temperature less than 200° C. to remove at least some of the solvent, including a sequence of three hot plate bakes at temperatures of 100° C., 100° C., and 180° C., respectively, for about two minutes each;
treating the wafer and spin-coated TiO₂ film with an oxygen plasma treatment to remove any remaining solvent and to density the TiO₂ film, including placing the wafer in a vacuum chamber at a pressure maintained at about 2.5 Torr, and with an oxygen flow of about 25 sccm, and providing an RF burst of about 400 W at about 13.56 MHz RF, thereby to ignite the plasma and densify the TiO₂ film;
repeating said spin coating, hot plate baking and treating steps as required; and
forming a microlens from the densified TiO₂ film.

11. The method of claim 10 wherein said spin coating includes spinning the wafer at an initial rate of about 300 RPM and then accelerating the wafer to a rate of about 2000 RPM for about thirty seconds.
